(19) United States
(12) Patent Application Publication
(10) Pub. No.: US 2008/0247128 A1
(43) Pub. Date: Oct. 9, 2008

(54) Composite Two Screen Digital Device

(76) Inventor: Soon Huat Khoo, Alameda, CA (US)

Correspondence Address: COURTNEY STANIFORD & GREGORY LLP, P.O. BOX 9686, SAN JOSE, CA, 95157, US

(21) Appl. No.: 12/062,452

(22) Filed: Apr. 3, 2008

Related U.S. Application Data
(60) Provisional application No. 60/921,774, filed on Apr. 3, 2007.

(51) Int. Cl. G06F 1/16

(52) U.S. Cl. 361/681; 361/683

(57) ABSTRACT

A composite multi-screen display device amalgamating various display technologies in a unique physical arrangement suited for small mobile digital devices is disclosed. A two-screen combination of a specific physical arrangement with software control facilitates use of a type of display architecture more suited for usage constraints of mobile electronic devices. The two screens are deployable in a variety of different positions relative to one another to facilitate modification of total viewing area and viewing angles. Additionally, the composite two screen digital device provides attachment of a mobile phone as a side screen display to increase the display area with software control directed by the device for all displays.

### CROSS-REFERENCE TO RELATED APPLICATIONS

The present application claims the benefit of the U.S. Provisional Application No. 60/921,774 entitled “Composite Two Screen Digital Device,” and filed on Apr. 3, 2007.

### FIELD

Embodiments of the invention relate generally to electronic devices, and more specifically, to portable computing devices having composite displays.

### BACKGROUND

Electronic display technologies are improving rapidly on several fronts for various device implementations and use scenarios from big screen high-definition televisions to bi-stable miniature cell phone displays. With regard to mobile digital devices, the many competing demands of mobility, low power consumption, screen readability in varying ambient lighting conditions, and so on, strain even the most advanced display technologies today. In addition, the huge growth of multimedia content in mobile devices is requiring ever larger screen displays in increasingly smaller devices. Broadband wireless connectivity will soon be given a boost by WiMax and HSUPA/HSDPA (High Speed Uplink/Downlink Packet Access) technologies. Wireless broadband will enable quad play technologies, which combine data, video, voice, and mobile communications capabilities. Mobile devices will be hard-pressed to realize their full potential unless the display industry develops a new generation of “mobile-friendly” displays.

The growing demand for mobile phones and other portable devices is dictating that displays combine thinness, light weight, ruggedness, low power consumption, high resolution, sunlight readability, and low cost. Screen size is the primary issue with current small digital devices displays, and the current trend toward downsizing of mobile devices, and the integration of different functions in single devices severely limits the amount of space that is available for the display. Display design in current generation mobile devices and small form factor computing devices rely on traditional single screen designs in which a unitary display is provided in the main body of the device. A small device necessarily means a small display. However, small displays can severely hamper readability and prevent overall user satisfaction with a device.

What is needed, therefore, is an improved physical arrangement and structure for display devices in small form factor digital devices, such as mobile phones, and the like.

What is further needed is a system that implements various new display technologies that are currently being developed to combine advantageous features of each of the display technologies in a single portable device platform.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a composite two-screen digital device in a first screen configuration, under an embodiment.

FIG. 2 illustrates the composite two-screen digital device in a second screen configuration.

FIG. 3 illustrates a top view of the composite two-screen digital device in a fully-folded in position, under an embodiment.

FIG. 4A illustrates an ideal display of an image across two screen displays in a folded-out configuration.

FIG. 4B illustrates the display of an image across two screen displays with a border gap.

FIG. 5 is a block diagram of control circuitry for a composite two-screen digital device, according to an embodiment.

FIG. 6 illustrates a composite two-screen digital device with one screen in a fully retracted, viewable configuration, under an embodiment.

FIG. 7 illustrates a compound device comprising a composite two-screen device in conjunction with a second portable device, under an embodiment.

FIG. 8 illustrates an embodiment in which a miniature projector projects an image onto a display area.

### DETAILED DESCRIPTION

Embodiments of a composite two-screen digital device incorporating various different display technologies for use in small form-factor digital devices are described. Such devices include personal digital assistant (PDA) devices, ultra mobile personal computers (UMPC), mobile gaming devices, personal media players (e.g., MP3 players), smartphones, and other mobile portable digital gadgets. Such embodiments are intended to overcome present drawbacks associated with compact electronic displays due to overly small screen sizes that hinder usability. Embodiments enable mobile devices with small form-factors, e.g., 3″×5″ or smaller to have an equivalent display screen area of about 7″ to 10″, though other screen areas are possible. Composite screen structures comprising two display screens can be used separately, singularly or as a unified whole. The screen displays are adapted to operate under varying ambient lighting conditions and to feature reduced battery consumption. This allows new and novel mobile applications to be supported.

In the following description, numerous specific details are introduced to provide a thorough understanding of, and enabling description for, embodiments of a composite two-screen digital device. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

The quality of an electronic device display screen is often a critical factor in its utility and desirability. Screen image quality generally increases with improvements in device hardware and software. Screen size, however, is fixed by the size of the device, and this parameter often has the greatest impact on the perceived quality of the images displayed on the device. For purposes of this description, the term ‘images’ refers to text, pictures, video, icons, or any other graphic that is displayed in computer and electronic screen displays.

In one embodiment, a composite two-screen device includes a diagonal 10-inch screen that is foldable down to a 7-inch or smaller screen size. Traditional screen technologies for small form-factor digital devices rely on LCD (liquid crystal display) technology. An LCD display comprises a thin, flat display device made up of any number of color or monochrome pixels arrayed in front of a light source or reflector. Such displays are typically housed in a rigid glass or hard plastic clear housing to protect the liquid crystal elements. Accordingly, present displays are typically non-flexible and relatively thick. In one embodiment, one or more screen elements of the composite two-screen digital device may incorporate one or more recently developed or developing screen technologies that feature advantage beyond standard LCD displays.

In an embodiment, a screen of the device comprises an organic light emitting diode (OLED) screen. These can include polymer light emitting diodes (PLEDs), or flexible OLED (FOLED) screens, which basically are organic light emitting devices built on flexible substrates, such as plastic or metallic foil. An important difference between LCDs and OLEDs is that the OLEDs are emissive displays, which means that they generate their own light. In contrast, LCDs are passive displays, and simply transmit or block an external light source to form an image. The light source for LCDs is typically ambient light reflected by a metallic layer behind the display, or backlight provided by a separate lighting system. Emissive displays do not need ambient light to be viewable, and do not require a backlight. This eliminates the cost, space, weight and power consumption of a backlighting system, and offers an image with much higher contrast. In addition, emissive OLED displays offer a much wider viewing angle than is provided by conventional LCD displays, for example, up to 160 degrees.

FOLED displays sit on pliable surfaces such as thin plastic strips or metal foils, and can be laminated onto a wall, instrument panel, or piece of clothing. Being flexible, they can be bent or rolled, allowing various types of retractable designs, such as a window shade. FOLED displays can offer significant performance advantages over LCD displays that are typically built on rigid glass substrates and contain a bulky backlight. OLED/FOLED technologies are anticipated to allow screens to be made with a thickness on the order of only 1 mm and with an end border width of 2 mm.

Another technology that may be adopted for one or more of the displays is mobile projection. With the advances in liquid crystal on silicon (LCoS) hologram and micro-electro mechanical (MEMS) technologies, projection displays have been developed that incorporate a low-cost projection engine embedded into a mobile phone, portable media player or ultra mobile personal computer, as well as head or eyeglass-mounted displays (HMDs). This embodiment incorporates a small projector into the digital device (e.g., cell phone), thus allowing people to share photos, mobisodes (mobile episodic TV video), and game play. The projectors may be laser-based, such as the type developed by Light Blue Optics Ltd, Cambridge, England. This system comprises a matchbox-sized video and image projector that uses miniature lasers to display video images, thus overcoming the size limitation of conventional projection techniques. This technology allows for the generation and display of high-quality holograms at video frame rates, thus making it suitable for television. The holograms are created with a ferroelectric LCoS panel. The panel is not used to create a pixilated image, but instead, the panel creates the Fourier transform of the image, which when illuminated by the laser light, creates an image when projected onto a screen. The concept requires no projection lens and offers wide dynamic range in the light output.

The composite two-screen digital device may also use one or more Flexible/Rollable displays. Rollable displays utilize TFTs (Thin Film Transistors), polymer electronics and electronic ink. For display applications, organic/polymer TFTs are used. These can be made using low temperature processing techniques, so that plastic is used as a substrate for the TFT layer. Together, the base and the TFT layer are on the order of 25 μm thick.

An alternative display technology is the High Efficiency Optical System (HEOS™) display architecture, by Liquavista™. Underpinning the HEOS architecture is the use of Electrowetting cell concepts which allow radically brighter and more efficient flat panel displays to be built.

Bi-stable electronic paper displays can also be used, such as are increasingly being used in electronic books (e-books). The display screens of such e-books require different performance metrics as compared to LCD screens of notebooks. Firstly these screens need to last for hours meaning they must draw much less power than LCDs. Next, they must be readable in bright ambient lighting conditions for outdoor reading conditions. In general, bi-stable electronic displays are most suited for these requirements.

Electronic paper, also called e-paper or electronic ink, is a display technology designed to mimic the appearance of regular ink on paper. Unlike a conventional flat panel display, which uses a backlight to illuminate its pixels, electronic paper reflects light like ordinary paper and is capable of holding text and images indefinitely without drawing electricity or using processor power, while allowing the paper to be changed. One important feature needed is that the pixels be image stable, so that the state of each pixel can be maintained without a constant supply of power. Technologies being applied to electronic paper include modifications of liquid crystal displays and electrochromic displays.

The display devices may also be based on Cholesteric Liquid Crystal (ChLCD) technology. These displays exhibit a high contrast ratio due to the reflective nature of the Cholesteric Liquid Crystal material with a monochromatic contrast ratio as high as 25:1 with a peak reflectivity that approaches 40% of the incident light, measured normal to the plane of the display. ChLCD products have peak reflectivities that can exceed 70%.

Another new display technology that can be used is the iMoD (interferometric modulator) display from Qualcomm™ MEMS Technologies. The basic element of the iMoD display is made up of two conductive plates. One of the plates is a thin-film stack on a glass substrate, the other a reflective membrane suspended over it and separated by an air gap. The element has two stable states. Without an applied voltage, the plates are separated, and light hitting the substrate is reflected back. When a voltage is applied to the plates, they are drawn together by electrostatic attraction and the light is absorbed, turning the element black. The elements are typically 10 μm to 100 μm on a side, and can be driven as a group to form a sub-pixel or pixel. Each pixel's color is determined by the gap between the plates, which affects the interference of the light hitting the element. The elements are also bi-stable, so the display only consumes power when a pixel changes state.

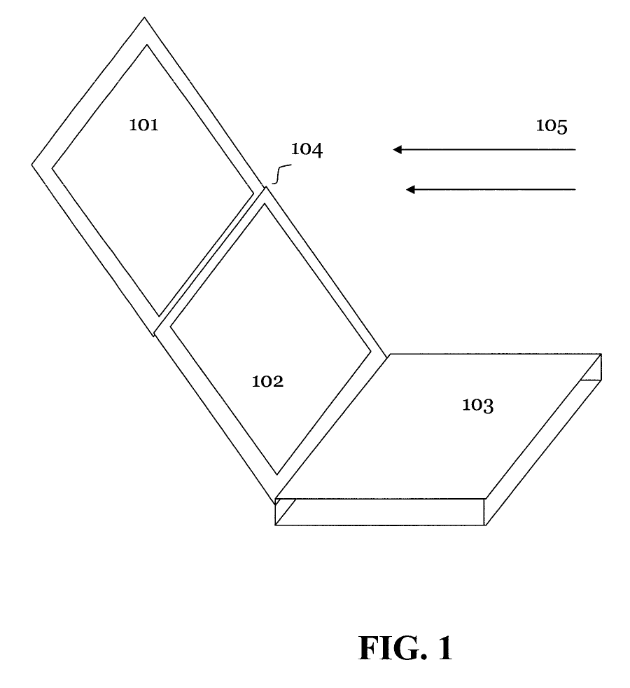

In general, a composite two-screen digital device can include displays based on one or more of the advanced technologies described above. FIG. 1 illustrates a composite two-screen digital device, under an embodiment. As shown in FIG. 1, a notebook computer is shown with a keyboard and electronics case or body 103. The two display screens are 101 and 102 connected to one another with a hinge at 104. The inner rectangle panels of 101 and 102 are the viewable areas of the screens. The joint or hinge area 104 and the margins of the displays are generally not usable for display. The direction of viewing is indicated by arrow 105.

In one embodiment, display panel 102 can be made of a traditional rigid glass protected LCD panel, OLED display or any glass substrate rigid display screen panel of about 5 mm thickness. Display panel 101 can be a display utilizing any of the advanced display technologies, such as FOLED or any of the other technologies, and can be connected to the body 103 through a hinge or similar structure. The top edge of the more rigid and robust lower panel 102 serves as the physical hinge and attachment support point for the much thinner and weaker panel 101.

The two screens 101 and 102 are coupled at a hinge line 104 which allows the panels to rotate relative to one another. For this embodiment, a physical rotating hinge that allows a panel to both collapse and rotate relative to another panel can be used. Alternatively, any flexible mating structure that enables relative movement between two or more panels can be used. FIG. 1 illustrates a configuration in which the screens are fully deployed in a folded-out position. In this configuration, both screens are visible to the user when he or she is viewing them from the direction of arrows 105. The hinge 104 also allows the screens 101 and 102 to fold back-to-back with their screens facing away from each other in a fully folded-in configuration.

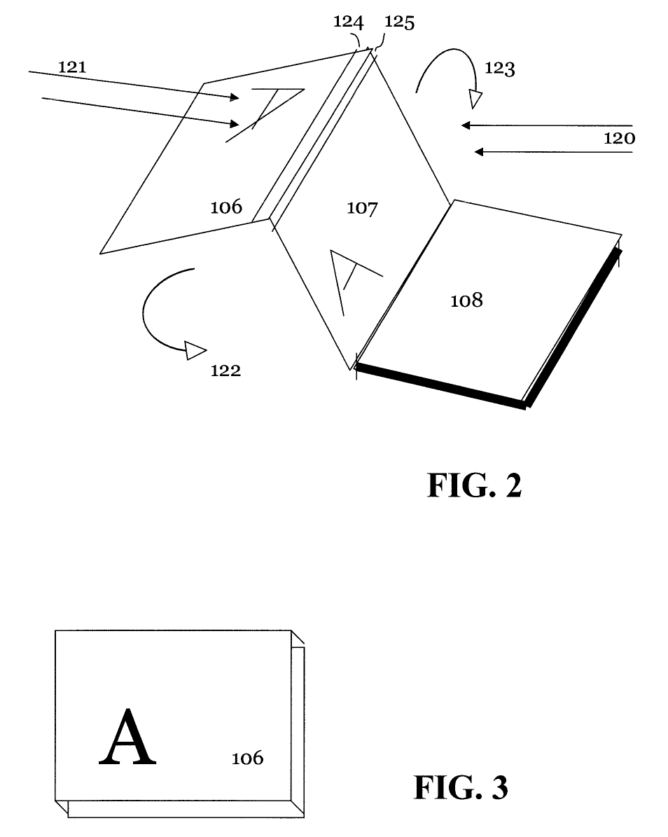

FIG. 2 illustrates the composite two-screen digital device in a folded-in configuration. In this configuration, the screen-panels 106 and 107 are folded to an intermediate position in which display panel 106 closes onto 107 in an anticlockwise direction as depicted by arrow 122. The folded-out configuration of FIG. 1 deploys the two screen panels for maximum display area across both display screens. In a partially folded-in configuration of FIG. 2, the screens are folded to about half the fully folded-out configuration when display pane 106 is closed onto display panel 107. In a fully folded-in configuration, both screens are folded onto the body 108 for mobility when not used. In this configuration, display panel 107 closes onto body 108 in a clockwise rotational direction as depicted by arrow 123.

When screen 106 fully closes onto 107 to go to a folded-in position, and screen 107 fully folds onto keyboard panel 108, the device is closed. In this configuration, the display area of screen 106 will be viewable from the outside of device. FIG. 3 illustrates a top view of the composite two-screen digital device in a closed position, under an embodiment. In the closed configuration, the displayable portion of panel 106 constitutes a viewable screen as illustrated by the letter A on screen 106. Alternatively, the backside of display screen 106 can be exposed in the closed position of FIG. 3, in which case no image is viewable when the device is closed, and the display area of screen 106 is protected.

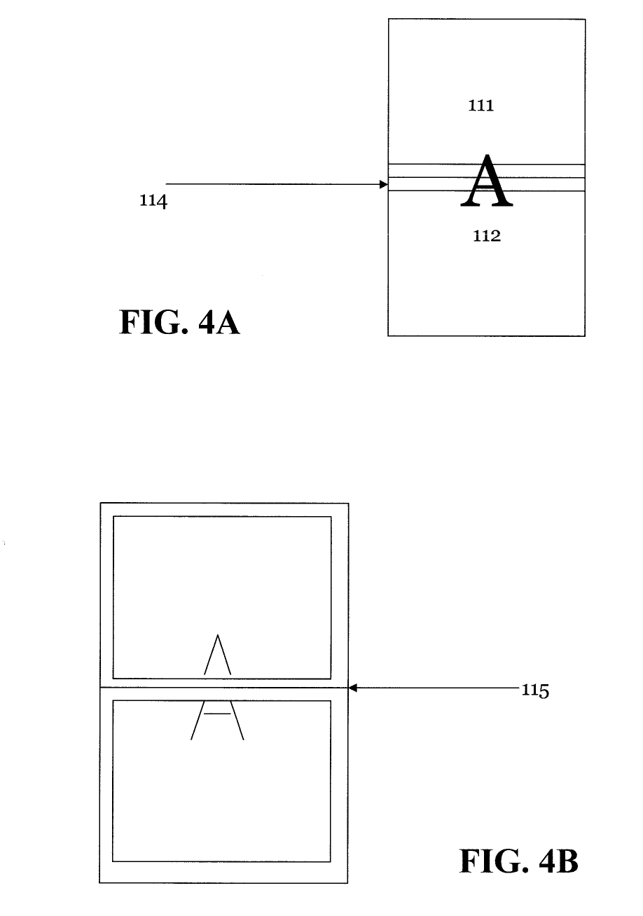

As shown in FIG. 2, border gaps 124 and 125 are present in the hinge area between the screen panels 106 and 107. These gaps result in the display of images that should be contiguous across both screens to be shown with a break. FIG. 4A illustrates an ideal display of an image across two screen displays in a folded-out configuration. In this case, the entire area between the two display panels, except for the actual physical air and frame material gap between the panels is usable as display area. In the practical case where there is some border area 124 and 125 for each display screen, the gap could become relatively large, as displayed in FIG. 4B. As shown in FIG. 4B, some images could be negatively affected by this gap. One partial solution is to have as narrow a gap 115 as possible between the screens, as well as very narrow borders 124, 125. This would allow the gap to become a minor irritation rather than a clear obstruction to display usability.

In one embodiment, one or more of the advanced display technologies described above are utilized to produce screens that have minimal border areas 124 and 125 and that produce minimal gap sizes 115 when deployed in a folded-out configuration. For example, bi-stable electronic paper display screens feature a very thin border, thus minimizing the non-displayable area around the periphery of the screen. Likewise, some OLED screens feature a top border of only around 2 mm.

Embodiments of the composite two-screen display device provide an advantage of featuring a relatively large overall display area while retaining portability and mobility through various deployment configurations of the two screens relative to one another and to the body of the device. In one embodiment, a two-screen processing function is provided to facilitate the display of different images on each of the two display screens. The two display screens can be configured to display images for a single file, such as a single document or graphic image across both screens. Thus, as shown in FIG. 3, both screens display an image from a single file, the letter ‘A’ across both screens. Alternatively, they can be configured to display images from two different files or applications. For example, one display panel may be configured to display the text of a word processing file, while the second panel displays a web page. For this embodiment, the two display screens may be controlled by separate display controllers, or different portions of a display control routine.

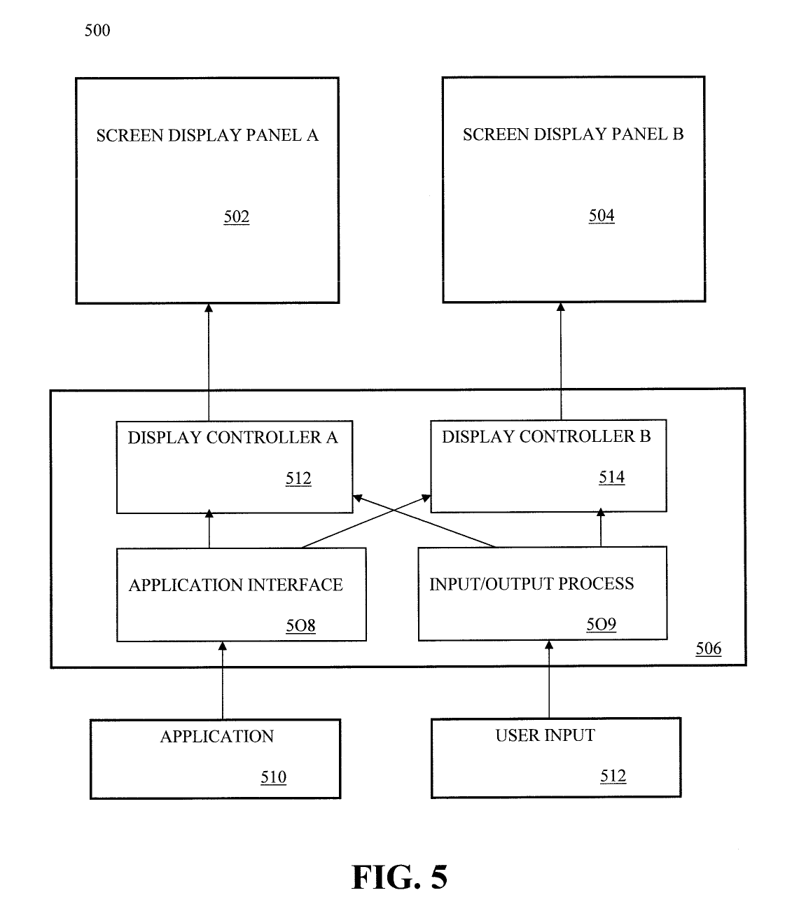

FIG. 5 is a block diagram of control circuitry for a composite two-screen digital device, according to an embodiment. Device 500 of FIG. 5 has two screen displays 502 and 504 coupled to a device body portion 506. Screen display A 502 is controlled by a display controller A circuit or function 512, and screen display B 504 is controlled by a display controller B circuit or function 514. Circuits 512 and 514 may be physically separate circuits within body 506, or they may be separate sections of the same circuit. Similarly, they may be separate portion of firmware or software programmed into a device or executed as routines in a processing unit within body 506. The display controller units 512 and 514 receive display commands from application interface 510 and input/output process 509. Application interface 510 is functionally coupled to application software or programs 510 executed by device 510. Likewise, input/output process 509 receives user input from input components 512, such as keyboard, mouse, reader, and other input means.

With reference to FIG. 2, the display screens 106 and 107 may be configured so that the actual display area for each screen is displayed in various orientations relative to the body 108. For example, there may be two persons facing across from one another with one viewing the device from direction 121 and the other viewing the device from direction 120. Such a display implementation where two people are seated across and see two different or identical screen images is especially useful in use scenarios such as collaborative work, instructional training, gaming, marketing, and so on.

The separate display device and display controller circuitry illustrated in FIG. 5 facilitates the ability to have each screen display two different applications or files while positioning the displays in a folded-out configuration, as shown in FIG. 1. For example, the top screen 101 may be configured to display a word file from an office personal computer using a remote access software application, while the bottom screen 102 may display a live web page. This allows data from different sources and locations to be compared and worked on simultaneously through the use of applications and user inputs that might come from different sources.

In a computer network environment, such as the Internet, the display screens may be configured to display content provided by different content providers, or different content provided by a single content provider or application. For example, ad messages or similar supplemental messages or pop-ups provided by an ad server may be displayed on a first display screen, while the main web page or content may be displayed on the second display screen.

In one embodiment, hardware or software processing units may also be provided in display screens 502 and 504 to help control the actual sources of images and their orientation. The configuration and use of the displays as either one large display or two different displays, and in one or two direction views, and other display control parameters can be assumed and choreographed by a central processing unit and its associated hardware electronics within the device body 506 as well as by functional circuitry in the display panels themselves, if such circuitry is provided.

The display control circuits 512 and 514 can be configured to control a specific screen type that is provided by respective screen display 502 and 504, or they may be configured to control various different display types so that they can adaptively accommodate different screen types that may be used with the device. In one embodiment, the system 500 can include an auto adjust feature that controls display parameters of the internally lighted screen with the use of an ambient lighting conditions sensor for purpose of blending image appearance of the first display panel and second display panel.

In one embodiment, the display screens 106 and 107 of FIG. 2 are made of different screen types. For example, screen display 106 may be an E-INK (electronic ink) color, bi-stable screen, while screen display 107 may be an OLED screen. In this case, screen panel 106 is a reflective display (like reading a printed paper) of low power consumption, and screen panel 107 is a light emissive display. Such a display combination, when deployed for a single image across both screens, results in two different contrasts, brightness and other image measurement metrics. In certain cases this may be somewhat disconcerting to the user. In this case, corrective circuitry may be provided to adapt the viewing characteristics of the two display devices.

The two displays can be configured to use screens that feature optimum characteristics for a given application or applications. For example, bi-stable displays require much less power than other types, thus helping to extend usable battery time, while and OLED screen provides a high quality image that can be of value when viewing a detailed image, such as a spreadsheet file. A very useful mix if the area of reading focus is narrow like when going through a detailed spreadsheet and this area of focus can be scrolled between panels, is to provide an OLED screen that gives a better image but consumes more power than E-INK, along with an E-INK screen that consumes less power but gives a poorer image. In this case, the overall display area may be relatively large (e.g., 10″). The image can be scrolled such that viewed areas are displayed on the OLED screen portion, while areas not focused on can be displayed in the E-INK area. Other optimal combinations of screen technologies can be combined in any hybrid configuration depending upon the uses and requirements of the composite device.

In one embodiment, the control circuitry of FIG. 5 can be used to minimize the effect of the gaps 124 and 125 caused by the junction between the two displays. In some applications that are sensitive to the display gap, such as high resolution video, the controllers may limit viewing to a single display of the two displays. Thus an adaptive application process may be provided that determines the amount of gap that is present, and that accordingly distributes the image to one or both of the screen displays as appropriate.

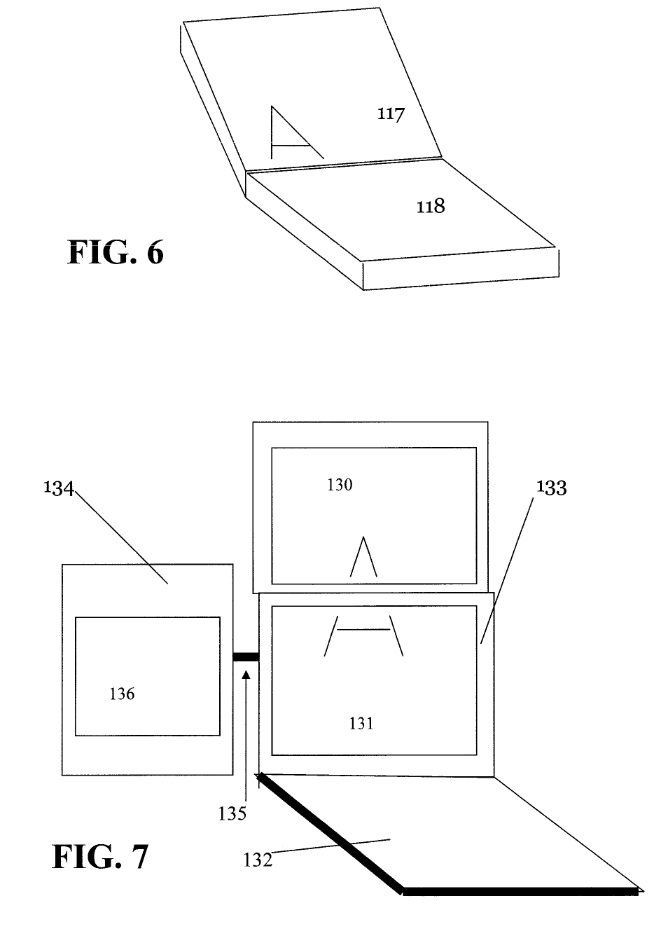

The different possible configurations can also allow optimum display given certain environmental conditions. For example, one advantage of bi-stable screens like E-INK panels is that they are suited for reading an in outdoor daylight or direct light conditions, which is something not possible for the OLED panels because of washout appearance in bright sunlight and the drain on battery power. FIG. 6 illustrates a composite two-screen digital device in a fully retracted, viewable configuration, under an embodiment. For this embodiment, display panel 117 represents a first panel, such as panel 106 of FIG. 2 retracted back-to-back on panel 107. In this embodiment, screen 117 is viewable just as in a standard notebook computer 118 except for a smaller display with a screen diagonal size of about 7″. This configuration is suited for watching video type files, surfing the net, retrieving e-mails, using the device in low ambient lighting conditions or in cramped conditions as in a car or economy airplane seats.

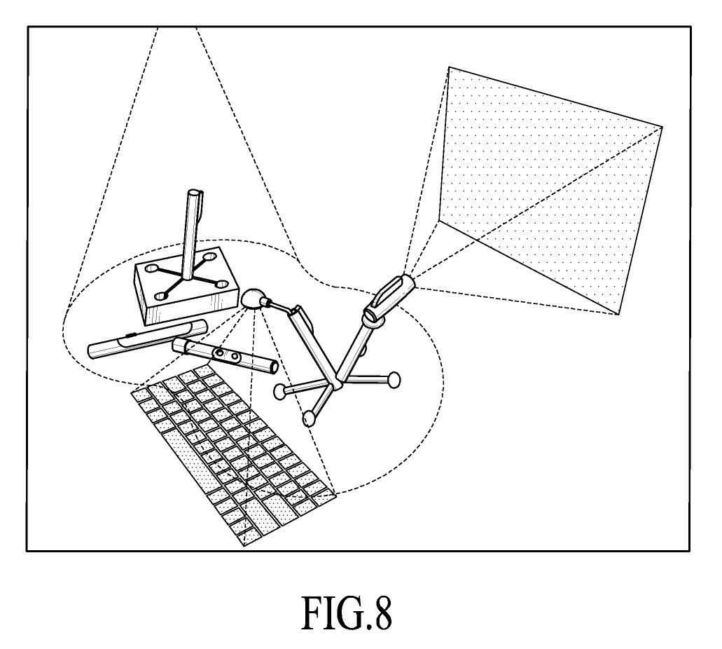

Another embodiment of a hybrid composite two-screen display device entails having panel 101 of the bi-stable, e-paper material type screen, and panel 102 made of traditional variants of LCD screens or glass substrate OLED screens. Supplementing this device can be a miniature mobile projector embedded in device body 103 which projects an upper half image onto panel 101, which will seamlessly display an image where panel 102 leaves off. This type of system covers the border gap 104. A white piece of paper functioning as white screen or any similar backing can be used to encompass panel 101 and gap 104. In effect, 101 and 102 act as one large 10″, or similar size screen with the electronics and display control software in body 103 synchronizing the miniature projector and panel 102 to give a well-proportioned (i.e., image keystone-geometry) seamless image. FIG. 8 illustrates an embodiment in which a miniature projector projects an image onto a display area.

As previously mentioned, electronic paper, also sometimes called e-paper or electronic ink, is a display technology designed to mimic the appearance of regular ink on paper. Therefore, in low ambient light condition, a miniature mobile projector embedded in body 103, which projects an upper half image onto panel 101, and may include a piece of paper as screen, solves the hurdle of bi-stable reflective e-ink screen not being usable in low light conditions. By leveraging advanced technologies, such as when full motion video, and flexible and pliable screens are cost effective for mass market, embodiments can include a two-sided continuous wrap-around screen for a clamp-shell type mobile internet device (MID) or UMPC. For this embodiment, a one-piece flexible color screen can be fashioned to wrap around the outside of such a portable electronic device. Such a display screen resembles the outside of a hard cover book, wherein the one piece pliable continuous screen and display area is on the outside front and back covers, and may include a rounded edge that also permits viewing. The display screen flexible material allows the MID/UMPC to be designed as clamp-shell device for smaller width and length dimensions but still incorporate a continuous 7″ to 12″ screen when clamp-shell device is deployed in an unfolded configuration. Text entry and other functions' button input can accommodated through a mini-USB (universal serial bus), or similar accessory attachment (like tiny foldable PDA keyboards), a slide out physical keyboard, image projected keys (virtual keyboard), onscreen soft-keys or a combination of such mechanisms.

Embodiments composite two-screen digital device are directed to the combined use of two screen-panels of same or different materials or technologies, aligned with one on top of the other for the purpose of facilitating a larger display in a mobile device. The two screen-panels being foldable into approximately half of its full spread size along a horizontal fold line 104. In an alternative embodiment, one or both of the display panels may be a flexible substrate display that is capable of being rolled. For this embodiment, the flexible panels are deployed or put away by rolling out or into a tube structure associated with the device body 103 or an adjacent rigid display panel.

In one embodiment, the image or images to be displayed can be processed and delivered by a central processing unit, being a unified one image spread over the two screen-panels or of two differing and unconnected and unrelated images, each occupying its designated screen panel. The combination of two screens can be configured with an inverted ‘V’ orientation with one screen's image display logically re-inverting the image so as to have two corresponding views from opposing sides of inverted ‘V’, such as shown in FIG. 2.

The combination of bi-stable power saving reflective display suited for high ambient lighting conditions as in outdoor daytime reading in one screen, together with another screen of emissive type display with an internal lighting source suited for use in dark ambient lighting conditions or when extreme screen brightness is required with attendant high power consumption of the screen is advantageous for various use conditions.

The image to be displayed may be sourced within the device itself, or from external sources. Such images can also be delivered through wireless delivery means. With regard to user input/output, mouse cursor control from a sender of an image computing device can be shown as a colored mouse pointer/tracker in the receiving screen of a composite two-screen display device to distinguish it from the device's own resident mouse pointer/tracker. The colored mouse pointer/tracker responds accordingly to mouse cursor control of image sender. A synchronization function can be used to synchronize the input mouse signals for both devices. Additional features, such as auto-shutdown of one or both of the two composite screens can be implemented for power saving when resident battery power source reaches a preset low level.

In one embodiment, the composite two-screen digital device is configured for use with a sideshow display application, such as is available in the Microsoft® Windows Vista™ operating system. This feature supports a secondary screen on a mobile computing device, and can be used to facilitate the viewing of important information whether the laptop, or other device is on, off, or in sleep mode.

To further maximize screen real estate, an additional combination of screen usage from two different devices can be provided. Many mobile phones today have larger screens for multimedia use. Popular phones, such as the Apple® iPhone feature a 3.5″ screen. Such as device can be used in conjunction with a UMPC that comprises a composite two-screen digital device that may feature an 8″-10″ screen when unfolded. Such a compound device allows the use of both devices' screens together in a coordinated manner. Such a compound device consists essentially of three display screens, and is effectively an enhanced two-screen device, that is a mobile phone screen and a UMPC incorporating the composite two-screen methodology.

This compound device includes a physical cable or connector link or a wireless link through Ultra wideband (UWB), Bluetooth, WiFi, Zigbee or any other short-range wireless protocol to coordinate the displays on the two devices. The display coordination can be managed and directed by a software application from a central processing unit (CPU) and its peripherals as on the composite two-screen device. One possible use of the display areas of a compound multi-screen device is in a word processing document whereby the supporting icons or widgets found in the Menu bar, Tool bar and Status bar can be displayed and selected on the mobile phone screen since a 3.5″ screen is sufficient for this purpose. This allows the larger (e.g., 8″) screen of the composite two-screen device to display only the main body of Word document. Thus maximizing the viewing area devoted to the main application, despite the relatively small size of the display device.

Another variation involves working with two or more applications instead of just a single application, and devoting different screens to the different applications. An example of this includes browsing the web on the main composite two-screen device and launching an instant messaging application like Yahoo® Messenger from this device, but having the display be shown on the mobile phone screen.

For this embodiment, the system includes a simple user interface for selections of commands from the icons displayed on the mobile phone, such as through a touch screen or capacitive stylus, surface acoustic wave, electromagnetic or keypad cursor based user input mechanism on the mobile phone. FIG. 7 illustrates a compound device comprising a composite two-screen device in conjunction with a second portable device, under an embodiment. As shown in FIG. 7, display screens 130 and 131 are the two composite panels of a complete UMPC 133 that includes a keyboard panel and housing 132 that encases most of the UMPC electronics and a CPU (central processing unit) as is customarily found in traditional notebook PCs. A second portable device 134, such as a mobile phone with a touch sensitive screen 136 is coupled to the UMPC 133 over a link 135. Link 135 represents a physical link, such as a cable or an adaptor device to carry the control, synchronization, and image display signals for all the screens 130, 131, and 136 to work in unison. Link 135 can also be implemented by wireless signals standards like Ultra wideband (UWB), Bluetooth, WiFi, Zigbee or any other short-range wireless protocol. The wireless embodiment allows for flexible placement of mobile phone 134 in relation to the UMPC 133. Another wireless standard that can be used is WiMedia UWB (ultra-wideband). In a present guise, UWB, with its primary vehicle wireless USB, can offer data rates up to a maximum of 480 Mbps over a distance of 30 m. UWB transmits information spread over a large width of radio spectrum (>500 MHz), generating radio energy at specific time instants. An UWB device's higher data rate also comes with the greater power efficiency of wireless USB (e.g., ten times more efficient than Wi-Fi and 50 to 70 times more efficient than Bluetooth).

Mobile phone that feature a wireless 3G evolution of CDMA/GSM/PCS wireless metropolitan area network capability adds certain benefits when the mobile phone is used in a ‘phone as modem’ status by permitting screens to display relevant information as applications are launched manually or automatically in the UMPC. For example, if the mobile phone screen engages in a web IM (instant messaging) session (using 3G) and the UMPC is deployed in a word processing session, anytime a phone call comes in, the UMPC could be triggered to examine the caller ID and take advantage of the UMPC's better data processing capability to display caller details and recent emails from contacts list onto the UMPC screen, which is information found mainly in the UMPC address book if a user's contacts' list is large and centralized in the UMPC hard disk storage. Also such large data set is more suitably viewed in a display larger than the smaller mobile phone screen.

The compound device takes advantage of the different relative applications for the devices. A mobile phone is small, but is usually carried at all times by a user. A UMPC, while larger, is still small enough to be eminently portable, and their increasing power and capabilities are such that they may eventually replace laptop computers.

Embodiments of a composite two-screen digital device have been described with respect to certain specific embodiments. It should be noted that many variations may be possible within one or more of the described embodiments. For example, the device in FIG. 1 was illustrated as a UMPC or small notebook computer, however, such as device can also embody a cell phone, PDA or other portable, small form factor electronic device. Likewise, screen sizes for the two screens were described as within the range of 7″ to 10″, however many other screen sizes are possible, depending upon actual design parameters of the device. In general, any size from about 3″ in a fully folded-in closed configuration to up to 15″ in a fully folded-out open configuration, or even larger is possible. For the compound device of FIG. 7, any two portable devices can be combined, such as any combination of one or more PDA devices, cell phones, UMPC's, laptop computers, and so on.

The display areas provided by the two screens of the composite device may be substantially similar to one another, as shown in FIG. 1, or they may be different, so that either screen may be substantially smaller than the other screen. Furthermore, although embodiments are directed to a two-screen display device, is should be noted that more than two screens can be used in such a composite device.

Embodiments of the composite screen device described herein may be applied to, or implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described system may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,”; “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the system may be presented in certain claim forms (if claims are present), the inventor contemplates the various aspects of the methodology in any number of claim forms. For example, while only one aspect of the system is recited as embodied in machine-readable medium, other aspects may likewise be embodied in machine-readable medium.

What is claimed is:

1. A computing device comprising:
a housing portion including a central processing unit;
a first display panel coupled to the housing portion through a first hinge structure; and
a second display panel coupled to the first display panel through a second hinge structure and aligned on top of the first display panel, the second display panel configured to be folded out to a first position relative to the first display panel to maximize an overall viewing area of the computing device, and folded in to a second position relative to the first display panel to reduce the viewing area to approximately half of the maximum overall viewing area.

2. The computing device of claim 1 wherein the first and second display panels utilize identical manufacturing technologies and are approximately of equal viewing size.

3. The computing device of claim 1 wherein the first and second display panels utilize different manufacturing technologies.

4. The computing device of claim 2 wherein the first display panel comprises a liquid crystal display screen and the second display panel is selected from the group consisting of: organic light emitting diode (OLED) screen, polymer light emitting diode (PLED) screen, flexible OLED, flexible substrate screen, high-efficiency optical system (HEOS) screen, and bi-stable electronic paper screen.

5. The computing device of claim 4 wherein the second display panel is a flexible substrate screen and is configured to be rolled into a tube shape upon deployment in the folded-in configuration.

6. The computing device of claim 1 wherein the second display panel is configured to be folded out to a third position relative to the first display panel to allow viewing of an image on an opposite side of the first display panel.

7. The computing device of claim 1 wherein a displayable image is processed and delivered by the central processing unit, and is configured to be a unified image that is displayed over both panels of the first and second display panels.

8. The computing device of claim 1 wherein a displayable image is processed and delivered by the central processing unit, and is configured to be a separate image with each component of the separate image configured to be displayed on a respective display panel of the first and second display panels.

9. The computing device of claim 4 wherein the second display panel comprises a bi-stable power saving reflective display suited for high ambient lighting conditions, and the first display panel is an emissive type display with an internal lighting source suited for use in dark ambient lighting conditions or when extreme screen brightness is required.

10. The computing device of claim 9 further comprising an auto adjust feature to control display parameters of the internally lighted screen with use of an ambient lighting conditions sensor for purpose of blending image appearance of the first display panel and second display panel.

11. The computing device of claim 1 further comprising a microprojector configured to project an image or image portion onto either or both of the first display panel or second display panel.

12. The computing device of claim 1 further comprising a wireless interface receiving a wireless delivery of an image from another computing device to either the first or second display panels to facilitate simultaneous viewing of an image in the another computing device and the first display panel or second display panel.

13. The computing device of claim 12 further comprising an input interface that is configured to color code input from the another computing device to differentiate it from input from the computing device.

14. The computing device of claim 1 further comprising an auto shutdown circuit configured to cut power to either of the first display panel or second display panel for power saving when a resident battery power source reaches a preset low level.

15. The computing device of claim 1 further comprising a display control circuit configured to transmit certain portions of a displayed object or user interface for display on the second display panel only.

16. The computing device of claim 1 wherein the certain portions are selected from the group consisting of: graphical user interface menu items, widgets, icons, status alerts, operating system messages, and advertising messages.

17. The computing device of claim 1 further comprising:
a link for coupling to a second portable computing device including a resident display panel; and
an interface circuit for coordinating display of images between the first and second display panels and the resident display panel for applications launched by the central processing unit of the computing device.

18. The computing device of claim 17 wherein the central processing unit is within a ultra-mobile personal computer (UMPC), and wherein the second portable computing device comprises a mobile communication device.
